(19) United States
(12) Patent Application Publication
(10) Pub. No.: US 2007/0053677 A1
(43) Pub. Date: Mar. 8, 2007

(54) Strobe system

(75) Inventors: Malcolm Steenburgh, Delta (CA); Michael Gibbons, Delta (CA); Stewart Kingdon, Richmond (CA); Roderick A. Barman, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Point Grey Research Inc., Vancouver, BC (CA)

(21) Appl. No.: 11/219,840

(22) Filed: Sep. 7, 2005

(51) Int. Cl. G03B 15/03

(52) U.S. Cl. 396/155

(57) ABSTRACT

A camera has a strobe output. When the camera acquires a sequence of images, a strobe pattern control determines for each image whether or not to apply a strobe signal to the strobe output according to a predetermined pattern. The predetermined pattern and the length of the sequence can be user defined by way of a suitable software interface, for example. The strobe output may be used to control a device such as a flash unit, a sound recorder or the like.

### TECHNICAL FIELD

The invention relates to cameras and, in particular, to cameras that include strobe outputs capable of triggering strobes or other devices.

### BACKGROUND

Many cameras have an electrical output that changes state (either by closing a circuit or providing an electrical signal) at the same time that the camera's shutter operates to acquire an image. This output, which may be called a strobe output, can be used to cause an external device to perform some action. For example, the camera can cause a strobe signal to appear at the strobe output to cause an external flash to fire.

A camera with ‘strobe’ functionality generally has the ability to emit an electrical pulse synchronized with the exposure of an image. The purpose of this signal is generally to allow for devices external to the camera to synchronize to the opening and/or closing of the shutter. One example of strobe functionality is the use of an external flash to light a scene during an exposure.

The inventors have discovered that the strobe signal provided by current cameras is not sufficiently versatile for many applications.

### SUMMARY OF THE INVENTION

This invention provides cameras that have configurable strobe signals. A camera according to the invention can be set up so that it does not provide a strobe signal every time the camera's shutter is actuated and/or so that the strobe signal changes in some predetermined way for different times that the camera's shutter is operated.

This invention also provides systems that incorporate multiple cameras that each have configurable strobe signals and methods for operating cameras to provide configurable strobe signals.

Further aspects of the invention and features of specific embodiments of the invention are described below.

### BRIEF DESCRIPTION OF THE DRAWINGS

In drawings which illustrate non-limiting embodiments of the invention,

FIG. 1 is a block diagram of a camera according to an embodiment of the invention;

FIG. 2 is a block diagram of a strobe pattern control;

FIGS. 3, 4 and 5 are block diagrams of alternative strobe pattern control arrangements; and,

FIG. 6 is a block diagram of a system incorporating two cameras.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

This invention provides cameras that have configurable strobe signals. A camera according to the invention can be set up so that it does not provide a strobe signal every time the camera's shutter is actuated and/or so that the strobe signal changes in some predetermined way for different times that the camera's shutter is operated.

In a simple embodiment, a camera provides strobe signals in a predetermined pattern. For example, the camera may be configured to provide a strobe signal only every N th time that the shutter operates where N is some integer other than one (e.g. 2, 3, 4, . . . ). In some embodiments the camera can be configured to provide strobe pulses on some arbitrary predetermined pattern of shutter operations.

The ability to configure strobe signals is particularly useful where there are multiple cameras. For example, two cameras may be operated to acquire a sequence of images with the shutters of both cameras triggered at the same time. A first camera may be set up to deliver a strobe pulse on every even numbered frame while a second camera is set up to deliver a strobe pulse on every odd numbered frame. Configurable strobe signals may also be used in some applications to allow a single camera to trigger a plurality of flashes, or other devices, to operate in a desired sequence.

Some examples of predetermined patterns are as follows:
N frames in a row out of a sequence having a total number of frames T (e.g. the strobe signal is provided for the last 3 frames in a sequence of 6 frames but not for the first three frames in the sequence of 6 frames); or
Specific selected frames within a defined sequence of frames (e.g. the strobe signal is provided for frames 1, 5 and 7 in a sequence of 8 frames but not for other frames in the sequence).

Instead of (or in addition to) providing or not providing a strobe signal according to some pattern, some embodiments vary the strobe signal in some predetermined pattern. For example, the strobe signal may be varied in any of the following ways:
the timing of the strobe signal relative to a time that the shutter is triggered may be varied in a predetermined pattern;
the strobe signal may be delivered to a selected one of a plurality of strobe outputs in a predetermined pattern;
the nature of the strobe signal may be altered (for example, each strobe signal may comprise a digital code and different digital codes may be sent, the amplitude and/or duration of an analog strobe pulse may be varied or the like) in a predetermined pattern.

Those skilled in the art will understand that there are a wide range of mechanisms that may be used to provide functionality as described above. The accompanying figures show examples of cameras that have programmable strobe outputs. These figures are not meant to be limiting.

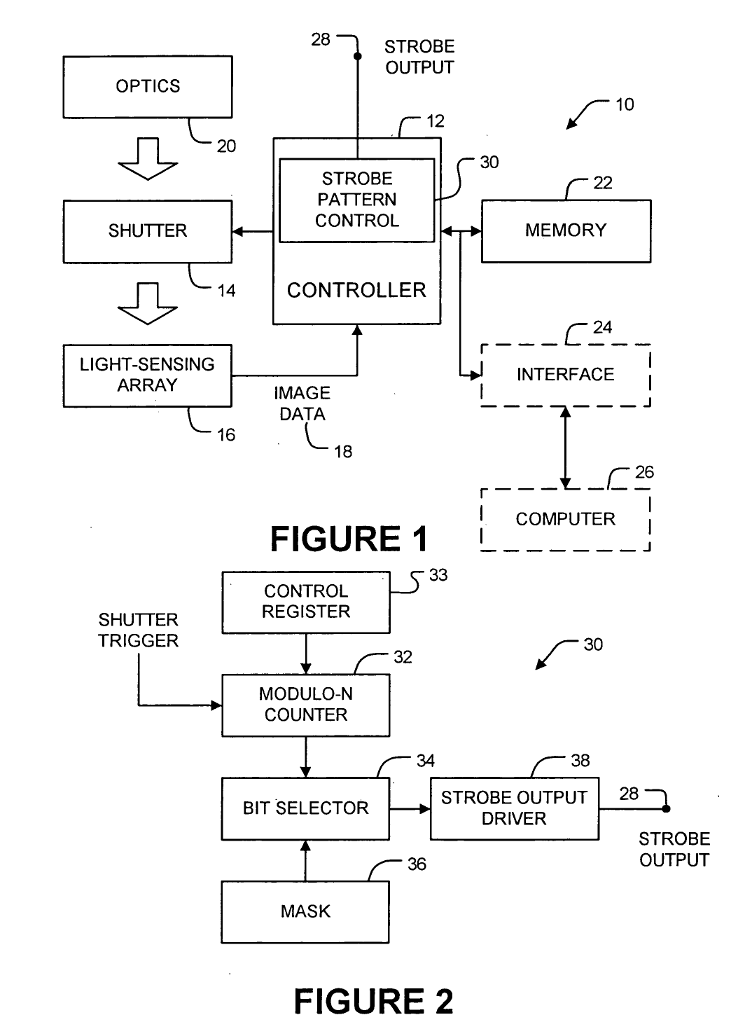

FIG. 1 is a block diagram showing a camera 10 having a controller 12 that controls a shutter 14. Each time shutter 14 is operated, an array 16 of light-sensitive elements (e.g. an array of charge-coupled devices “CCD”s) acquires an image 18 of light provided by way of an optical system 20. Images 18 are stored in a data store 22 or sent to an optional computer 26 for storage and/or processing by way of an optional interface 24.

Optical system 20 may comprise any suitable system of lenses or the like that directs light onto light-sensing array 16 in such a way that light-sensing array 16 can acquire images 18. Shutter 14 may comprise a mechanical shutter, an electronic shutter or any suitable combination of mechanical and electronic mechanisms that results in image data being acquired by light-sensing array 16 when shutter 14 is triggered by controller 12.

Controller 12 drives a strobe output 28. Strobe output 28 may, for example, comprise an electrical contact that changes from a first logic level to another for the duration of a strobe pulse and then reverts to the first logic level. Strobe output 28 may be provided externally to camera 10 and may also be provided to devices such as integrated flash units or sound recorders that are integrated with camera 10. Strobe output 28 may be connected to control external devices such as flash units, other cameras, sound recorders and the like.

A strobe pattern control 30 controls whether or not a strobe signal is applied to strobe output 28 for a particular operation of shutter 14. Strobe pattern control 30 may be partly or entirely integrated with controller 12 or may operate independently of controller 12 in response to signals that indicate that shutter 14 is being triggered.

FIG. 2 illustrates a possible construction of a strobe pattern control 30. Strobe pattern control 30 includes a modulo-N counter that determines a length of the predetermined pattern which determines whether or not a strobe signal will be provided at strobe output 28 for each frame or exposure. In the illustrated embodiment, a control register 33 stores a value that sets a value of N for modulo-N counter 32. A user can configure strobe pattern control 30 to provide a pattern of a desired length by writing to control register 33.

Modulo-N counter 32 is incremented on each occurrence of a shutter trigger signal. The shutter trigger signal also triggers shutter 14 (or is generated synchronously with a signal that triggers shutter 14). For example, where N is set to 3, counter 32 cycles through the values: 0, 1, 2, 0, 1, 2, etc. The value in modulo-N counter 32 operates a bit selector 34 that selects a bit from a mask 36.

Mask 36 has a length at least equal to N. One bit of mask 36 corresponds to each possible value of modulo-N counter 32. For each frame or exposure, modulo-N counter 32 has a particular value. The bit of mask 36 corresponding to that value indicates whether or not a strobe signal is to be generated for that frame or exposure. For example, a bit value of “1” could indicate that a strobe signal should be generated while a bit value of “0” could indicate that a strobe signal should not be generated. Bit selector 34 applies the value of the selected bit to a control input of a strobe output driver 38. Strobe output driver delivers, or does not deliver, a strobe signal to strobe output 28 depending on the value of the applied bit.

In an alternative embodiment, the bits of mask 36 are replaced with, or correspond to, expanded data structures such that values from the expanded data structure corresponding to each frame or exposure control the strobe signal generated for the frame or exposure. For example, the expanded data structures could include values representing one or more of:
a quantity (i.e. a number of times the strobe signal should trigger a strobe or other device). It is often useful, for example, to trigger a flash multiple times for one opening of a camera shutter;
duration of each triggering pulse in the strobe signal;
a magnitude of the strobe signals;
where the strobe signal will include multiple triggering events, a time between the triggering events; and
so on.

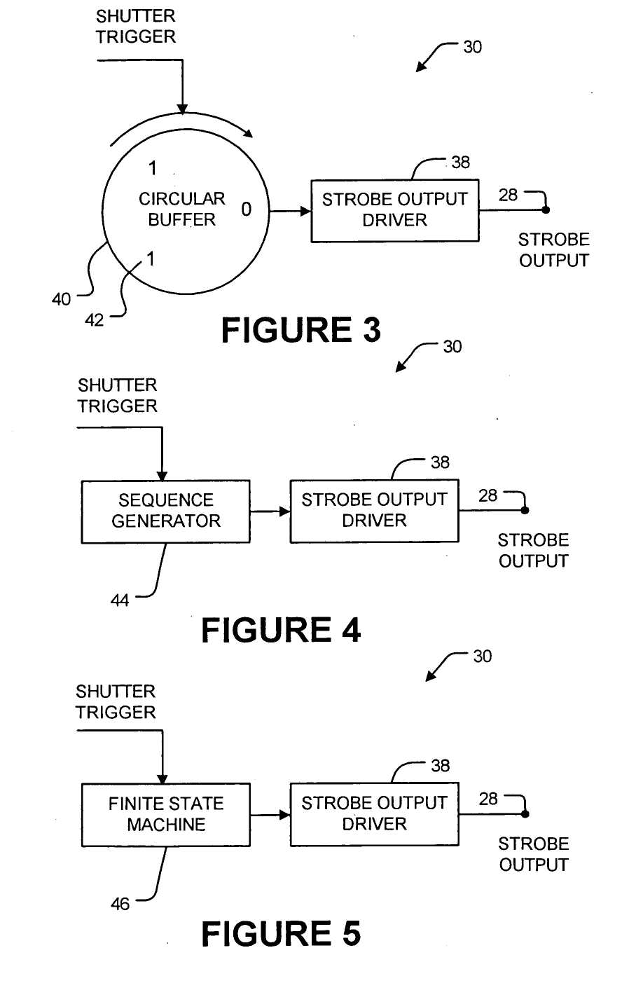

Many other alternative constructions are possible. For example, FIG. 3 shows another configuration for a strobe pattern control 30. In FIG. 3, the desired pattern is represented by values 42 stored in a circular buffer 40. The length of the pattern is determined by the number of values 42 in circular buffer 40. The application of the shutter trigger signal causes circular buffer 40 to rotate so that the next value is applied to the control input of strobe output driver 38.

FIG. 4 shows another configuration for a strobe pattern control 30. In FIG. 4, the desired pattern is represented by a function in a sequence generator 44. For each application of a shutter trigger signal, sequence generator 44 generates a next value in a sequence. The values may be determined, for example, by an algorithm executed by sequence generator 44. The algorithm may be recursive in the sense that it generates a next value by performing a calculation based on one or more of a current value and one or more past values.

FIG. 5 shows another configuration for a strobe pattern control 30. The apparatus of FIG. 5 is similar to the apparatus of FIG. 4 except that sequence generator 44 is replaced by a finite state machine that changes states in response to shutter trigger signals and provides state-dependent outputs to the control input of strobe output driver 38.

It can be advantageous in some cases to store information that indicates the strobe signal that was applied for a particular frame. This information may, for example, be stored in the image data for a frame. For example, the first few pixels of image data may be replaced by values containing information about the image data or the circumstances under which it was acquired. Control circuit 12 may optionally store strobe information indicating whether or not a strobe signal was provided for a particular frame and/or information indicating the type of strobe signal provided for the particular frame. This information may be stored either:
in the image data for the frame;
together with the image data for the frame; or,
in some separate data store in a manner such that the information is associated with the image data for the frame.

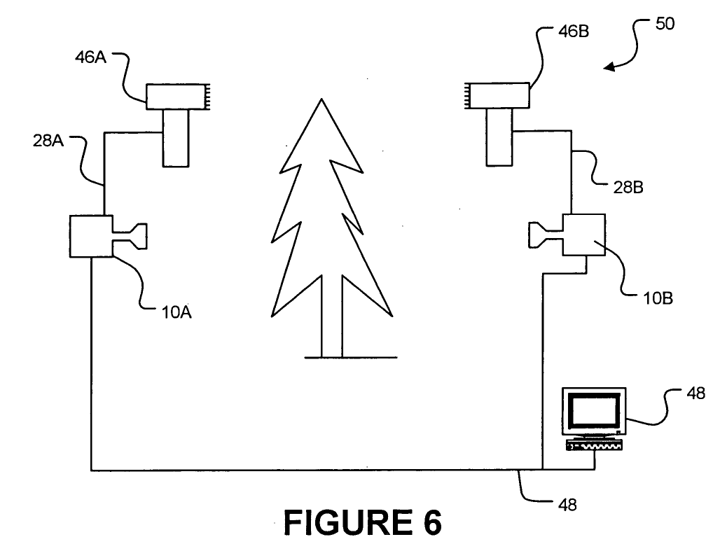

FIG. 6 shows a system 50 comprising two cameras 10A and 10B. Cameras 10A and 10B have strobe outputs 28A and 28B respectively that control electronic flash units 46A and 46B respectively. Cameras 10A and 10B are connected by a signal bus 48. Cameras 10A and 10B maintain synchronization with one another by monitoring signals on signal bus 48. Signal bus 48 is connected to provide image data from each of cameras 10A and 10B to a computer 48.

Cameras 10A and 10B operate synchronously with one another and each acquire a sequence of images of a scene. Camera 10A outputs strobe signals that cause flash 46A to fire for a first predetermined pattern of the images of the sequence of images. Camera 10B outputs strobe signals that cause flash 46B to fire for a second predetermined pattern of the images of the sequence of images. The first and second predetermined patterns are different from one another.

Certain implementations of the invention comprise computer processors which execute software instructions which cause the processors to perform a method of the invention. For example, a controller for a camera may comprise one or more processors that implement methods of the invention by executing firmware instructions in a program memory accessible to the processor. The invention may also be provided in the form of a program product. The program product may comprise any medium which carries a set of computer-readable signals comprising instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like or transmission-type media such as digital or analog communication links. The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. For example:
The camera may be sensitive to infrared light or light of other wavelengths outside of the visible range.
The strobe signal may cause actions other than triggering a flash. For example, the strobe signal may: cause a device to acquire or preserve an audio sample, trigger another camera to acquire an image, make a measurement, take a sample of something or the like.
The strobe signal may consist of or include optical signals or mechanical signals instead of or in addition to electrical signals.
   Accordingly, the scope of the invention is to be construed in accordance with the substance defined by the following claims.

What is claimed is:

1. A camera comprising:
a shutter;
a controller operable to trigger the shutter to acquire a sequence of images; and,
a strobe pattern control configured to generate strobe signals at a strobe output, the strobe pattern control having access to a predetermined pattern comprising information specifying, for each image in the sequence of images at least one of:
whether or not to generate a strobe signal for that image; and
a type of strobe signal to generate for the image;
wherein the strobe pattern control is configured to generate strobe signals according to the predetermined pattern synchronously with triggering of the shutter by the controller.

2. A camera according to claim 1 wherein the strobe pattern control comprises a modulo-N counter and the sequence of images has a length of N images, where N is an integer.

3. A camera according to claim 2 comprising a control register containing a value, wherein the value in the control register determines a value of N.

4. A camera according to claim 1 wherein each of the images comprises image data and the controller is configured to associate with the image data for each of the images strobe information indicating at least one of:
whether a strobe signal was generated for the image; and
a type of strobe signal generated for the image.

5. A camera according to claim 4 wherein the controller is configured to store the strobe information for each of the images in association with the image data for the image.

6. A camera according to claim 4 wherein the controller is configured to write the strobe information for each of the images into the image data for the image.

7. A camera according to claim 1 wherein the strobe pattern control is configured to generate a strobe signal only for every N th image where N is an integer and N>1.

8. A system comprising at least two cameras according to claim 1 wherein the cameras are configured to acquire images synchronously with one another, each of the cameras is configured to generate strobe signals at its strobe output according to a predetermined pattern, and the predetermined patterns are different for different ones of the cameras.

9. A system according to claim 8 wherein the at least two cameras include a first camera and a second camera and the predetermined pattern for the first camera causes the first camera to generate strobe signals only for images for which the second camera does not generate strobe signals.

10. A system according to claim 9 wherein the predetermined pattern for the second camera causes the second camera to generate strobe signals for all images for which the first camera does not generate strobe signals.

11. A method for acquiring a sequence of images, the method comprising:
providing a camera;
providing a predetermined pattern comprising information specifying, for each image in a sequence of images to be acquired, at least one of:
whether or not to generate a strobe signal for that image; and
a type of strobe signal to generate for the image; and,
operating the camera to acquire the sequence of images while generating strobe signals according to the predetermined pattern.

12. A method according to claim 11 wherein the predetermined pattern comprises information specifying, for each image in the sequence of images to be acquired, whether or not to generate a strobe signal for that image.
